(19) United States
(12) Patent Application Publication
(10) Pub. No.: US 2018/0057999 A1
(43) Pub. Date: Mar. 1, 2018

(54) FABRIC AND METHOD FOR MANUFACTURING THE SAME

(71) Applicants: HONDA MOTOR CO., Ltd., Tokyo (JP); TB Kawashima Co., Ltd., Shiga (JP)

(72) Inventors: Rie HAYASHI, Saitama (JP); Kohei OHARA, Shiga (JP); Takayuki OISHI, Shiga (JP); Tatsuya FUKUI, Shiga (JP)

(21) Appl. No.: 15/671,762

(22) Filed: Aug. 8, 2017

(30) Foreign Application Priority Data
Aug. 23, 2016 (JP) 2016-162875

(51) Int. Cl. D06M 13/08; B32B 5/02; B32B 5/18; B32B 27/36; D06M 13/282; D06M 15/263; D06M 15/507; D06M 15/564

(52) U.S. Cl. CPC D06M 13/08; D06M 2101/32; B32B 5/18; B32B 27/36; D06M 13/282; D06M 15/263; D06M 15/507; D06M 15/564; B32B 2260/021; B32B 2260/046; B32B 2262/0276; B32B 2305/022; B32B 2305/18; B32B 2307/3065; B32B 2307/7265; B32B 2367/00; B32B 2601/00; D06M 2200/11; D06M 2200/30; B32B 5/02

(57) ABSTRACT

Provided are a fabric having excellent stain resistance and flame retardancy, and a method for manufacturing the fabric. The fabric includes a first coating layer and a second coating layer on one surface of a polyester fabric impregnated with a fluorine-based water-and-oil repellent agent; in which the first coating layer contains a fluorine-based water-and-oil repellent agent and the second coating layer contains a flame retardant; the first coating layer being on the fabric side, and the second coating layer being on the side opposite to the fabric of the first coating layer.

### CROSS-REFERENCE TO RELATED APPLICATIONS

The present application claims priority to Japanese Patent Application No. 2016-162875, filed on Aug. 23, 2016, the disclosure of which is incorporated herein by reference.

### BACKGROUND OF THE DISCLOSURE

### Field of the Invention

The present invention relates to a fabric having flame retardancy and stain resistance, and a method for manufacturing the same.

### Description of the Related Art

For fabrics used for interiors of a vehicle, a marine vessel, an aircraft or the like (e.g., a fabric used for a vehicle seat such as an automobile seat and a fabric used for a trimming material such as a door lining), flame retardancy is required and at the same time, higher stain resistance is required because of difficulty in washing or cleaning such fabrics.

As a stain resistant treatment, it is known to apply a water-and-oil repellent coating to the front surface of the fabric, and as a flame retardant treatment, it is known to apply a flame retardant coating to the rear surface of the fabric. However, when the water-and-oil repellent coating is applied to the fabric, there arises a problem that fabric texture is impaired (hardened). Further, when the fabric is subjected to the flame retardant treatment, the stain resistance tends to deteriorate.

In particular, when a vehicle such as an automobile is exposed to sunlight for a long time in summer, the temperature inside the vehicle may increase to about 80° C. As an effect of a fluorine-based water-and-oil repellent agent, however, water-and-oil repellency against a liquid having a temperature around 80° C. tends to deteriorate, so that it is difficult to maintain high stain resistance under such high temperature conditions.

As a fabric exhibiting excellent flame retardancy and water repellency even under a high temperature, JP-A-2004-76202 discloses a fabric of which the surface is covered with a flame retardant and a siloxane polymer, but has not fully discussed about stain resistance against oil.

### SUMMARY OF THE INVENTION

The present invention has been made so as to solve the above-described problems, and an object of the present invention is to provide a fabric having excellent stain resistance and flame retardancy.

As a result of repeated studies in order to solve the above problems, the present inventors succeeded in overcoming the above-described problems by impregnating a polyester fabric with a fluorine-based water-and-oil repellent agent, thereafter, forming a coating layer (first coating layer) containing the fluorine-based water-and-oil repellent agent on one surface of the fabric, and further forming a coating layer (second coating layer) containing a flame retardant thereon.

In other words, the fabric of the present invention has

a first coating layer and a second coating layer on one surface of a polyester fabric impregnated with a fluorine-based water-and-oil repellent agent;

in which the first coating layer is a layer containing a fluorine-based water-and-oil repellent agent and the second coating layer is a layer containing a flame retardant;

the first coating layer being on the fabric side and the second coating layer being on the side opposite to the fabric of the first coating layer.

A desired stain resistance can be achieved by impregnating a polyester fabric with a fluorine-based water-and-oil repellent agent. However, when a flame-retardant back coat layer is formed on the fabric in order to further impart flame retardancy to the fabric, stain resistance deteriorates.

On the other hand, the present invention has succeeded in satisfying excellent stain resistance and flame retardancy by providing on one surface of the fabric (in particular, the rear surface of the fabric), a water and oil repellent coating layer and a flame retardant coating layer sequentially from the fabric side.

Further, a foam sheet may be bonded to the above one surface (coating layer formed surface) of the fabric. The fabric having the foam sheet bonded to one surface thereof is suitable for use as an exterior material for vehicle seats or the like. The fabric of the present invention is fully bonded to the foam sheet and is difficult to be peeled off from the foam sheet.

The fluorine-based water-and-oil repellent agent content of the first coating layer, per unit area of fabric, is preferably in the range of 0.5 g/m² to 5.0 g/m².

The first coating layer may further contain a flame retardant.

As a preferred example of the fabric according to the present invention, a fabric may be used in which the fluorine-based water-and-oil repellent agent content and the flame retardant content of the first coating layer, per unit area of fabric, are in the range of 0.5 g/m² to 3.0 g/m² and 0 g/m², respectively; and the flame retardant content of the second coating layer, per unit area of fabric, is in the range of 30 g/m² to 60 g/m².

As another preferred example thereof, a fabric may be used in which the fluorine-based water-and-oil repellent agent content and the flame retardant content of the first coating layer, per unit area of fabric, are in the range of 2.5 g/m² to 5.0 g/m² and 25 g/m² to 45 g/m², respectively; the flame retardant content of the second coating layer, per unit area of fabric, is in the range of 15 g/m² to 35 g/m²; and the flame retardant content of the first coating layer is larger than that of the second coating layer.

The present invention relates to a method for manufacturing the fabric including the steps of:

immersing a polyester fabric in a treatment liquid containing a fluorine-based water-and-oil repellent agent to incorporate the treatment liquid thereinto, followed by drying the fabric;

forming a first coating layer containing a fluorine-based water-and-oil repellent agent on one surface of the fabric; and

forming a second coating layer containing a flame retardant on the first coating layer.

According to the present invention, a fabric having high flame retardancy and stain resistance can be provided. When the fabric of the present invention has a foam sheet (a slab urethane sheet, etc.) bonded to its coating layer formed surface, peeling-off between the fabric and the foam sheet less occurs.

### BRIEF DESCRIPTION OF THE DRAWINGS

FIG. 1 is a diagram illustrating the fabric of the present invention, wherein FIG. 1A shows the fabric having first coating layer (2) and second coating layer (3) on the rear surface side of polyester fabric (1), and FIG. 1B shows the fabric further having foam sheet (4) bonded thereto.

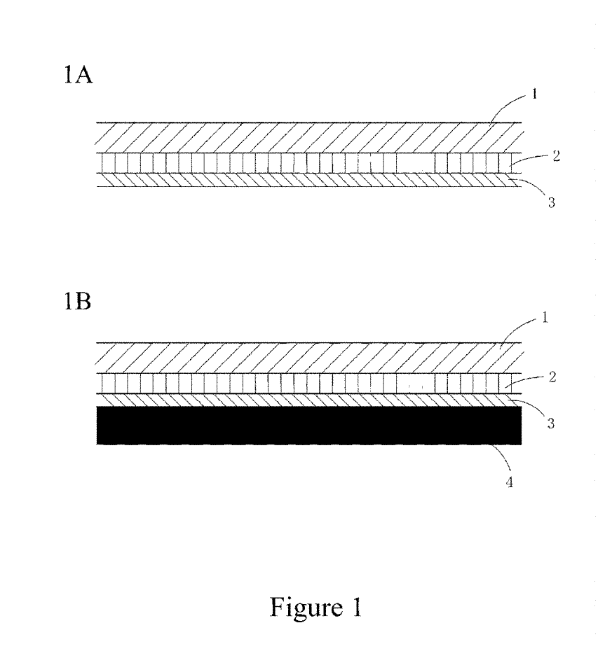

### DETAILED EXPLANATION OF THE PREFERRED EMBODIMENTS

In the present invention, a polyester fabric impregnated with a fluorine-based water-and-oil repellent agent has a fluorine-based water-and-oil repellent coating layer and a flame retardant coating layer on one surface (in particular, a rear surface) thereof, in which the fluorine-based water-and-oil repellent coating layer is placed between the fabric and the flame retardant coating layer.

Even though the fabric is impregnated with the fluorine-based water-and-oil repellent agent, when a flame-retardant back coat layer is formed on the fabric in order to further impart flame retardancy, the stain resistance of the fabric lowers. Instead of forming the flame-retardant back coat layer on the fabric, even though the fabric is processed in a bath containing a flame retardant-containing treatment liquid, it is difficult to impart satisfactory flame retardancy to the fabric and stain resistance tends to lower in this case as well. The reason why the flame retardant treatment lowers the stain resistance is that an emulsifier or a surfactant is contained in the flame retardant composition used when fiber products are subjected to flame retardant treatment, so that these agents may be considered to adversely affect stain resistance.

When the fluorine-based water-and-oil repellent agent is added to a flame retardant coating composition to form a flame-retardant stain-resistant coating layer, stain resistance is improved as compared with the case of using a flame retardant agent alone, but it is still difficult to achieve stable stain resistance. Further, when a foam sheet such as slab urethane is bonded to the coated side of the fabric, the fabric and the foam sheet are prone to separate from each other.

On the other hand, in the present invention, when a first coating layer containing a fluorine-based water-and-oil repellent agent is formed on one surface of the fabric, and a second coating layer containing a flame retardant is formed on the first coating layer, a fabric excellent in both stain resistance and flame retardancy, and further having a high peel strength to the foam sheet can be provided. When the flame retardant coating layer and the water-and-oil repellent coating layer are inverted so that the fabric, flame retardant coating layer, and water-and-oil repellent coating layer are laminated in this order, not only a desired stain resistance fails to achieve, but also the peel strength to the foam sheet lowers.

The term “desired stain resistance” as used herein means that as shown in the section of Examples, the fabric has an initial water repellency in accordance with JIS L1092 of 95 or higher, and in the salad oil stain resistance test described in the section of Examples, no oil stain is observed on the front and rear surfaces of the fabric and on the soft wipe after 24 hours at 83° C. The temperature of 83° C. tends to lower the effect of the fluorine-based water-and-oil repellent agent. The fabric of the present invention, however, allows stains caused by oily foodstuffs to be easily removed because even when salad oil is dropped onto the surface of the fabric and the fabric is then left at a temperature of 83° C., the fabric does not let the oil through.

The term “desired flame retardancy” as used herein means the case where a test is carried out in accordance with “Flammability of Interior Materials” defined in Federal Motor-Vehicle Safety Standard (FMVSS) and the fabric does not ignite even after a 15-second flame application (N), or the fabric ignites by applying a flame but after the flame crosses A marked line, the flame is extinguished within a burnt distance of 101 mm within a burning time of 60 seconds. In particular, it is preferable that the fabric is evaluated to be “N” according to the above criteria.

In the friction fastness test described in the section of Examples, it is also preferable that the fabric of the present invention achieves grade 4 or higher in both the “DRY” and “WET” tests.

Further, when the foam sheet is laminated by fusion bonding to one surface (a surface having a coating layer) of the fabric by the method described in the section of Examples, it is preferable that a peel strength of 1.0 N/cm or more can be achieved in the peel strength test described in the section of Examples.

As described above, the fabric of the present invention has a first coating layer containing a fluorine-based water-and-oil repellent agent and a second coating layer containing a flame retardant laminated on one surface of a polyester fabric impregnated with the fluorine-based water-and-oil repellent agent, in this order from the fabric side. Such fabric can be produced by the method of the present invention including the steps of immersing a polyester fabric in a treatment liquid containing a fluorine-based water-and-oil repellent agent, followed by drying the immersed fabric; forming a first coating layer containing the fluorine-based water-and-oil repellent agent on one surface (in particular, the rear surface) of the fabric; and forming a second coating layer containing a flame retardant on the first coating layer.

The constitution of the present invention will be described in more detail below.

As a ground fabric used in the present invention, a polyester fabric is selected in terms of easily achieving the desired flame retardancy.

The term “polyester fabric” as used herein means a fabric containing polyester fiber, and may be not only a woven fabric, a knitted fabric, and a nonwoven fabric composed of polyester fiber alone, but also a blended fabric, an interknitted fabric or the like used in combination of polyester fiber and other fibers (natural fibers such as cotton and wool, or chemical fibers such as polyamide, rayon, and acryl). The proportion of the polyester fiber in the fiber constituting the fabric is preferably 60% by weight or more, more preferably 70% by weight or more, especially preferably 80% by weight or more, and even more preferably 90% by weight or more. An especially preferable fabric is composed of polyester fiber, having a thickness of 0.2 mm to 3.0 mm (basis weight of 100 g/m² to 700 g/m²), in particular, a thickness of 0.4 mm to 2.6 mm (basis weight of 200 g/m² to 500 g/m²).

In the present invention, the polyester fabric is impregnated with a fluorine-based water-and-oil repellent agent before forming the two coating layers on one surface thereof (stain-resistant finish). The fluorine-based water-and-oil repellent agent is a compound containing a perfluoroalkyl group in which all or a part of hydrogen atoms in the hydrocarbon group are replaced by fluorine atoms. In the present invention, in particular, a polymer containing a monomer having a perfluoroalkyl group is preferably used. Examples of the fluorine-based water-and-oil repellent agent that may be used in the present invention include a commercially available product under the trade name of AsahiGuard E-SERIES from Asahi Glass Co., Ltd. and a commercially available product under the trade name of NK GUARD S series from Nicca Chemical Co., Ltd.

A fluorine-based water-and-oil repellent agent to be used for immersion treatment may be one or more kinds (e.g., two to three kinds).

The term “fabric impregnated with a fluorine-based water-and-oil repellent agent” as used herein means a fabric having the fluorine-based water-and-oil repellent agent adhered to not only the surface of the fabric but also the fiber inside the fabric.

As a method of impregnating the polyester fabric with the fluorine-based water-and-oil repellent agent, immersion treatment generally called a padding treatment or a dip-nip treatment may be employed. For example, an aqueous treatment liquid containing a fluorine-based water-and-oil repellent agent (solid content) in an amount of 1.0% to 5.0% by weight, and more preferably 1.5% to 3.5% by weight is prepared, the polyester fabric is immersed in the treatment liquid (e.g., for 2 to 5 minutes) and squeezed with rollers (mangles) or the like, thereby allowing the treatment liquid to be contained in the entire fabric, followed by drying the fabric, so that a fabric impregnated with a fluorine-based water-and-oil repellent agent can be obtained. Appropriate dry conditions are, for example, a temperature of 110° C. to 170° C., in particular, 120° C. to 160° C., and a time of about 1 minute to 5 minutes.

The amount of the fluorine-based water-and-oil repellent agent to be impregnated in the fabric by the stain-resistant finish can be calculated by a concentration of the fluorine-based water-and-oil repellent agent in the treatment liquid and a squeezing rate. The impregnated amount, per unit area of fabric, of the fluorine-based water-and-oil repellent agent contained in the dried fabric is suitably in the range of 2.0 g/m² to 8.0 g/m², more preferably 3.0 g/m² to 7.0 g/m², and even more preferably 4.0 g/m² to 6.5 g/m².

After the above-mentioned immersing and drying steps (stain-resistant finish), cleaning (reduction cleaning or warm water cleaning) treatment may be performed. In general, fiber products dyed at a high dye concentration are subjected to reduction cleaning in order to remove excess dye which may cause color transfer or the like. The reduction cleaning is usually a step of placing a fiber product in an aqueous solution containing hydrosulfite and sodium hydroxide, and cleaning it with the aqueous solution having a temperature of about 80° C. (e.g., 65° C. to 90° C., more preferably 70° C. to 85° C.). Even though a fabric dyed at a high dye concentration, however, is subjected to reduction cleaning after dyeing, the dye easily exudes from the fabric due to the stain-resistant finish, which in turn the friction fastness of the fabric deteriorates after the stain-resistant finish (color transfer easily occurs). Therefore, the fabric dyed at a high dye concentration is preferably subjected to reduction cleaning even after the stain-resistant finish. In addition, the stain-resistant finish tends to deteriorate (harden) the texture of the fabric, but the texture can be improved by cleaning. Therefore, it is preferable that a fabric free from the friction fastness problem (a fabric dyed at a low dye concentration) is also subjected to cleaning treatment after the stain-resistant finish. The fabric dyed at a low dye concentration may be cleaned with hot water (e.g., 65° C. to 90° C., more preferably 70° C. to 85° C.) not by reduction cleaning. In the cases of both the reduction cleaning and the hot water cleaning, the cleaning time can be set in the range of 1 minute to 60 minutes, for example, about 15 to 40 minutes.

The selection of either reduction cleaning or hot water cleaning in the cleaning step after the stain-resistant finish can be determined by a measure of color transferability to the fabric (color transfer easily occurs in the fabric dyed at a high dye concentration and less occurs in the fabric dyed at a low dye concentration). Examples of the fabric dyed at a high dye concentration include fabrics dyed at a dye concentration of about 5% owf or more such as black, blue, red, purple, dark gray, dark blue and dark green. Examples of the fabric dyed at a low dye concentration include fabrics dyed at a dye concentration of less than about 5% owf such as white, light gray, beige, and cream. More specifically, when the stain-resistant finished fabric has a friction fastness of grade 4.0 or higher in both the DRY and WET tests, reduction cleaning can be judged as unnecessary, and when less than grade 4.0, reduction cleaning can be judged as necessary. The friction fastness is measured in accordance with JIS L0849 (Test methods for color fastness to rubbing).

The fabric is subjected to the stain-resistant finish and arbitrarily the cleaning treatment, followed by drying (e.g., dried at a temperature of 110° C. to 170° C., in particular, 120° C. to 160° C. for about 1 to 5 minutes). Thereafter, a coating layer (first coating layer) containing a fluorine-based water-and-oil repellent agent is formed on one surface (in particular, the rear surface) of the fabric. As the fluorine-based water-and-oil repellent agent in the first coating layer, those described above as the fluorine-based water-and-oil repellent agent used in the immersion treatment can be used; the same agent as or a different agent from the fluorine-based water-and-oil repellent agent used in the immersion treatment may be used; and the fluorine-based water-and-oil repellent agent may be used alone or in combination of two or more kinds.

The composition for forming the first coating layer preferably contains the fluorine-based water-and-oil repellent agent in an amount of 1.5% to 9.0% by weight, more preferably 2.0% to 7.0% by weight, and even more preferably 2.5% to 6.0% by weight (proportions of the weight of the solid content of the fluorine-based water-and-oil repellent agent to the total weight of the solid content of the coating composition).

The fluorine-based water-and-oil repellent agent content of the first coating layer, per unit area of fabric, is preferably in the range of 0.5 g/m² to 5.0 g/m², more preferably 0.7 g/m² to 4.0 g/m², and even more preferably 0.8 g/m² to 3.5 g/m².

The total amount of the fluorine-based water-and-oil repellent agent impregnated in the fabric and that contained in the coating layer, per unit area of fabric, is preferably in the range of 2.5 g/m² to 10.0 g/m², more preferably 4.0 g/m² to 9.5 g/m², and even more preferably 5.0 g/m² to 9.0 g/m².

In the present invention, the first coating layer is formed on one surface (in particular the rear surface) of the fabric, and a second coating layer containing at least one kind of a flame retardant is formed on the first coating layer. The flame retardant to be used in the second coating layer is preferably a phosphorus flame retardant having a solubility to water at 20° C. of 4% (4 g/100 g of water) or less. Examples of the phosphorus flame retardant include those selected from the group consisting of phosphonic acid esters, phosphoric acid amides, phosphoric acid ester amides, aromatic phosphoric acid esters, halogen-containing phosphoric acid esters, inorganic polyphosphates, diammonium phosphate, and the like. In particular, an organic phosphorus flame retardant is preferable. An example of the preferred flame retardant is a phosphonic acid ester-based flame retardant and/or melamine phosphate.

The composition for forming the second coating layer preferably contains the flame retardant in an amount of 25% to 75% by weight, more preferably 30% to 70% by weight, and even more preferably 35% to 65% by weight (proportions of the weight of the solid content of the flame retardant to the total weight of the solid content of the coating composition).

The flame retardant content of the second coating layer, per unit area of fabric, is preferably in the range of 15 g/m² to 60 g/m², more preferably 20 g/m² to 55 g/m², and even more preferably 22 g/m² to 53 g/m².

By adding the flame retardant to the above-mentioned first coating layer, the flame retardant may be contained both in the first and the second coating layers. Such constitution allows the fabric to impart higher flame retardancy. As the flame retardant to be contained in the first coating layer, those described above as the flame retardant in the second coating layer can be used; the same agent as or a different agent from the flame retardant used in the second coating layer may be used; and the flame retardant may be used alone or in combination of two or more kinds.

On the other hand, when a water-and-oil repellent agent is contained in the second coating layer, the peel strength between the fabric and the foam sheet lowers, which has been obtained when the foam sheet is bonded to the fabric. Therefore, the second coating layer preferably may not substantially contain a water-and-oil repellent agent (the water-and-oil repellent agent content of the second coating layer, per unit area of fabric, is preferably less than 0.1 g/m², and more preferably 0 g/m²).

When a flame retardant is contained in the first coating layer, the stain resistant effect due to the first coating layer tends to lower. Therefore, a sufficient amount of fluorine-based water-and-oil repellent agent is preferably present in the first coating layer. More specifically, when a flame retardant is contained in the first coating layer, the fluorine-based water-and-oil repellent agent content of the first coating layer, per unit area of fabric, is preferably 2.5 g/m² or more, and more preferably 2.8 g/m² or more.

Further, an excessive amount of the flame retardant in the first coating layer tends to deteriorate the stain resistant effect, so that the amount of the flame retardant in the first coating layer, per unit area of fabric, is preferably 45 g/m² or less, and in particular 40 g/m² or less.

When the flame retardant is contained in the first coating layer, high flame retardancy can be achieved even though the flame retardant in the second coating layer is reduced. The reduction of the amount of the flame retardant in the second coating layer leads to reduction in the thickness of the second coating layer, thereby improving the peel strength at the time of bonding to the foam sheet. Therefore, the flame retardant content of the first coating layer is preferably larger than that of the second coating layer.

As an example of the preferred fabric of the present invention when the first coating layer contains a fluorine-based water-and-oil repellent agent but not contain a flame retardant, a fabric may be used in which the fluorine-based water-and-oil repellent agent content of the first coating layer, per unit area of fabric, is in the range of 0.5 g/m² to 3.0 g/m² (more preferably 0.8 g/m² to 2.5 g/m²), and the flame retardant content of the second coating layer, per unit area of fabric, is in the range of 30 g/m² to 60 g/m² (more preferably 32 g/m² to 55 g/m²).

As an example of the preferred fabric of the present invention when the first coating layer contains both a fluorine-based water-and-oil repellent agent and a flame retardant, a fabric may be used in which the fluorine-based water-and-oil repellent agent content of the first coating layer, per unit area of fabric, is in the range of 2.5 g/m² to 5.0 g/m² (more preferably 2.7 g/m² to 4.0 g/m²), the flame retardant content of the first coating layer, per unit area of fabric, is in the range of 25 g/m² to 45 g/m² (more preferably 30 g/m² to 40 g/m²), the flame retardant content of the second coating layer, per unit area of fabric, is in the range of 15 g/m² to 35 g/m² (more preferably 20 g/m² to 27 g/m²), and the flame retardant content of the first coating layer is larger than that of the second coating layer.

The composition for forming the first and the second coating layers according to the present invention contains a binder for adhering (fixing) the fluorine-based water-and-oil repellent agent or the flame retardant to the fabric. As a preferred binder, a polyester resin, an acrylic resin, or a urethane resin may be used. For an application requiring flame retardancy, a polyester resin is preferably used, and for an application requiring cost or texture, an acrylic resin is preferably used.

As the polyester resin, acrylic resin, or urethane resin, commercially available ones used as a binder for usual fabric coating composition can be used.

In particular, the binders are preferably of soft type, an acrylic resin having a Tg of −30° C. to −45° C. is preferable, and an urethane resin having a minimum film-forming temperature (MFT) of 0° C. to 5° C. is preferable.

The first and second coating compositions may contain a thickener. As the thickener, an acrylic acid-based thickener or a urethane associative thickener can be used. The thickener content of the coating layer, per unit area of fabric, is usually in the range of about 0.5 g/m² to 5.0 g/m².

The viscosity of the first and second coating compositions is suitably in the range of about 20,000 mPa·s to 70,000 mPa·s, and in particular preferably about 35,000 mPa·s to 55,000 mPa·s. As used herein, the viscosity of the coating composition means a viscosity measured using a B-type viscometer (BH type) at a measured temperature of 20° C. with a rotor No. 6 at a rotation speed of 10 rpm, after an elapse of 30 seconds from the start of the rotation.

The first and second coating compositions can be applied to the fabric using a knife coater, a comma coater, a bar coater, a die coater, a kiss-roll coater, or a gravure coater or the like. After the application of the first or second coating compositions to the fabric, drying conditions are, for example, drying temperature in the range of 110° C. to 170° C., in particular 120° C. to 160° C., and drying time of about 2 to 5 minutes.

The binder content of the first coating layer, per unit area of fabric, is preferably in the range of about 15 g/m² to 80 g/m² (in particular, about 20 g/m² to 70 g/m²), and the binder content of the second coating layer, per unit area of fabric, is preferably in the range of about 10 g/m² to 50 g/m² (in particular, about 10 g/m² to 40 g/m²). When the thickener is an acrylic resin or a urethane resin, the combined amount of the binder and the thickener resin is preferably within the above range.

An excessively small amount of the binder tends to fail to securely fix the fluorine-based water-and-oil repellent agent and the flame retardant to the fabric. On the other hand, an excessively large amount thereof may harden the texture.

The amounts of the first and second coating layers on the fabric (after drying), per unit area of fabric, are each preferably in the range of 25 g/m² to 85 g/m², and the amount of these two layers combined is preferably in the range of 80 g/m² to 140 g/m², and more preferably 90 g/m² to 130 g/m².

As described above, when the flame retardant is contained in the first coating layer, the amount of the second coating layer can be reduced. Therefore, in such cases, for example, the amount of the first coating layer can be in the range of 40 g/m² to 85 g/m², preferably 50 g/m² to 70 g/m², the amount of the second coating layer can be in the range of 25 g/m² to 50 g/m², preferably 30 g/m² to 45 g/m².

The fabric of the present invention may be bonded to the foam sheet on the coating side of the fabric (on the second coating layer). Examples of the foam sheet include a polyurethane foam (slab urethane or the like) having a thickness of 2.0 mm to 10 mm. A laminated composite composed of the fabric and the foam sheet is suitably used as an exterior material of a seat (usually, a molded article made from a urethane cushioning material) in a vehicle such as an automobile.

Examples of the method of bonding the foam sheet to one surface of the fabric include flame laminate processing in which a surface layer on one side of the foam sheet is melted with a gas burner to be fused to the one surface of the fabric (on the second coating layer) where the first and second coating layers are formed.

In addition, the method of the present invention may include a dyeing step and/or a flame retardant processing step before the immersion treatment using the fluorine-based water-and-oil repellent agent. For example, the fabric may be subjected to dyeing treatment in a bath where a disperse dye is supplied or flame retardant processing in a bath where an organic phosphorus flame retardant is supplied. An excessive flame retardant in the flame retardant processing in the bath may deteriorate stain resistance of the fabric. Therefore, the amount of the flame retardant (solid content) supplied in the in-bath processing, in the unit owf (supply amount relative to the weight of the fabric), is suitably in the range of 0.2% to 2.0% owf, in particular about 0.4% to 1.3% owf, and the amount of the flame retardant impregnated in the fabric is suitably in the range of 0.5 g/m² to 4.0 g/m², in particular about 1.0 g/m² to 3.0 g/m².

Further, the dyeing and flame retardant steps may be carried out in the same bath. In addition, when the fabric is dyed at a high dye concentration (about 5% owf or more) in the dyeing step, reduction cleaning may be carried out after dyeing.

The present invention will be described in more detail below by means of Comparative Examples and Examples, without intending to limit the present invention thereto.

### EXAMPLES

### Example 1

A polyester fabric (polyester: 100%, basis weight: 360 g/m²) was treated according to the steps shown in Table 1.

Regarding the steps of Table 1, for the dyeing treatment (step 1), 0.84% owf (in terms of solid content) of a phosphoric acid amide flame retardant commercially available under the trade name of VIGOL FV-6010 from Daikyo Chemical Co., Ltd. was added together with a black or beige disperse dye, and in-bath flame retardant processing was carried out simultaneously with dyeing. The dyes were used so that a black dye had a dye concentration of about 9.8% owf and a beige dye had a dye concentration of about 0.25% owf (both in terms of solid content).

For the stain-resistant finish (step 4) by dip-nip process, a mixture of a fluorine-based water-and-oil repellent agent commercially available under the trade name of AsahiGuard E-SERIES from Asahi Glass Co., Ltd. and a fluorine-based water-and-oil repellent agent commercially available under the trade name of NK GUARD S series from Nicca Chemical Co., Ltd. was used, and the polyester fabric was immersed (at 150° C. for 2 minutes and 30 seconds) in an aqueous dispersion containing 2.44% by weight (in terms of solid content) of the fluorine-based water-and-oil repellent agent. Subsequently, the immersed fabric was squeezed under a pressure of 3.0 kgf/cm² with mangles (pick-up rate: 60%).

In the first and second coating steps, using a first coating composition or a second coating composition, which was adjusted so as to have a viscosity in the range of 45,000 mPa·s to 55,000 mPa·s, a coating layer was formed on the rear surface of the fabric with a knife coater.

The flame retardant used in the first and second coating steps (in steps 10 and 12) was an organic phosphorus flame retardant (non-halogen flame retardant coating agent containing an acrylic resin as a binder and mainly containing a phosphonic acid ester flame retardant (solubility to water at 20° C.: 4.0% or less)) commercially available under the trade name of Nonnen CP-104GKO from Marubishi Oil Chemical Co., Ltd.

The fluorine-based water-and-oil repellent agent used in the first coating step (steps 8 and 10) was commercially available under the trade name of NK GUARD S series from Nicca Chemical Co., Ltd.; the acrylic resin used in step 8 was an acrylic resin-containing water dispersion commercially available under the trade name of VONCOAT 901 from DIC Corporation; the urethane resin was an urethane resin-containing water dispersion commercially available under the trade name of SUPERFLEX E-2000 from DKS Co., Ltd.; and the polyester resin was a polyester resin-containing water dispersion commercially available under the trade name of PLAS COAT Z from Goo Chemical Co., Ltd.

In step 8, an acrylic resin thickener commercially available under the trade name of Vanasol KB-660 from Shin-Nakamura Chemical Co., Ltd. was used.

Subsequently, the processed fabric manufactured according to the steps shown in Table 1 was tested by the following methods in terms of friction fastness, flame retardant performance of the fabric, stain resistance against salad oil, and water repellency. On the rear surface side of the processed fabric (the surface having the first and/or second coating layer(s) formed thereon), a slab urethane sheet having a thickness of 3.0 mm was heat-sealed to form a laminated composite (formed by flame lamination in which a surface layer on one side of the slab urethane sheet was melted with a gas burner, and the melted layer was then bonded to the rear surface of the processed fabric), and thereafter, peel strength between the fabric and the urethane foam and flame retardant performance of the laminated composite were measured.

### <Friction Fastness>

A dry test (DRY) and a wet test (WET) were carried out with the processed fabrics in accordance with JIS L0849 (Test methods for color fastness to rubbing). Staining was evaluated as grades 1 to 5 using a gray scale for assessing staining (JIS L0805). The grade equal to or higher than grade 4 is evaluated as Pass.

### <Flame Retardant Performance>

A test was carried out in accordance with “Flammability of Interior Materials” defined in Federal Motor-Vehicle Safety Standard (FMVSS) to evaluate the flame retardant performance.

When a fabric (a processed fabric alone or a laminated composite) did not ignite even after a 15-second flame application (N), or when a fabric ignited by applying a flame but after the flame crossed A marked line, the flame was extinguished within a burnt distance of 101 mm within a burning time of 60 seconds (101 mm/min or less), the fabric was evaluated as Pass.

<Stain Resistance Test with Salad Oil >

A sheet having a size of about 10×10 cm square was prepared from each sample (processed fabric) as a test piece and the test was then carried out. A soft wipe (Elleair Prowipe) was placed on a tray, and the test piece was put thereon (a coated test piece was put on the soft wipe with its coating surface (rear surface) downward). Salad oil was dropped in 5 places on the test sample with a pipette so that each droplet on the sample has a diameter of about 5 mm or 0.05 ml of the oil is dropped in each place.

The tray was allowed to stand still in a Geer oven at 83° C. for 24 hours. After an elapse of 24 hours, the tray was taken out and then observed whether the salad oil dropped spots on the front surface of the test piece were wet or not (the oil stained or not), or whether any oil stain due to the salad oil was present on the rear surface and the soft wipe or not. When no oil stain was observed on the front and rear surfaces of the test sample and on the soft wipe placed underneath the test piece, the fabric was evaluated as Pass

### <Water Repellency>

A test piece cut into a size of 20 cm×20 cm was attached to a test piece holding frame in a device defined in JIS L1092 6.2 so as not to cause a test piece to become wrinkled.

Into a funnel was poured 250 ml of distilled water or ion-exchange water and sprayed onto the front surface of the test piece.

Next, the frame with the test piece was removed from the support, held horizontally on one end of the frame, tapped once against a solid object on the other end of the frame while the front surface of the test piece faces downward. The frame with the test piece was further rotated by 180°, and the same procedure as above was performed to remove excess droplets.

The wetting state of the test piece still attached to the frame was rated.

0: Complete wetting of the front surface (the sprayed surface) and rear surface

50: Complete wetting of the front surface

70: Half wetting of the front surface at small discrete areas through the cloth

80: Wetting of the front surface with small discrete droplets

90: No wetting of but adherence of small droplets to the front surface

95: No wetting of but slight adherence of small droplets to the front surface

100: No wetting of and no adherence of droplets to the front surface

The fabric having an initial water repellency of 95 or higher was evaluated as Pass.

### <Peel Strength of Laminate>

Test pieces having a size of 25 mm in width and 150 mm in length were cut out from a processed fabric laminated with an urethane foam, specifically three test pieces each were cut out in the vertical and horizontal directions at the center and the both ends of the fabric. At the end of the test piece in the longitudinal direction, the fabric and the urethane foam were peeled off about 50 mm by hand. This peeled end was pulled at a tensile speed of 200 mm/min and the peeling load was recorded.

An average load was determined from the recorded load in the chart, an average of three sections in each of the directions was determined to calculate the peel strength (N/cm). The fabric having a peel strength of 1 N/cm or higher was evaluated as Pass.

Table 1 shows the processing steps and the performance of the processed fabric, and Table 2 shows the solid contents of the components imparted to the ground fabric in the dip-nip step, first coating step, and second coating step, as an amount per unit area of fabric (unit: g/m²).

TABLE 1
Processing steps and performance of processed fabric

| Processing details | | | | Blank | No. 1 | No. 2 | No. 3 | No. 4 | No. 5 |
|---|---|---|---|---|---|---|---|---|---|
| Steps | 1 | Dyeing | Black [BL]/Beige [BE] | BL | BL | BL | BL | BL | BL |
| | | | In-bath flame retardant processing | (+) | (+) | (+) | (+) | (+) | (+) |
| | | | Done (+)/Not done (−) | | | | | | |
| | 2 | Reduction | Hydrosulfite 1 g/L | | | | | | |
| | | cleaning (RC) | Sodium hydroxide 1 g/L | | | | | | |
| | | | 80° C. × 30 min | | | | | | |
| | 3 | Drying | 2 min (BL: 130° C. BE: 150° C.) | | | | | | |
| | 4 | Stain-resistant | Dip-nip | | | | | | |
| | | finish | Fluorine-based water and | | | | | | |
| | | | oil repellent agent 8.2% | | | | | | |
| | | | (150° C. × 2.5 min) | | | | | | |
| | 5 | Drying | 2 min (BL: 130° C. BE: 150° C.) | | | | | | |
| | 6 | Reduction | Hydrosulfite 1 g/L | | | | | | |
| | | cleaning (RC) | Sodium hydroxide 1 g/L | | | | | | |
| | | | 80° C. × 15 min | | | | | | |
| | 7 | Drying | 2 min (BL: 130° C. BE: 150° C.) | | | | | | |
| | 8 | First coating | Fluorine-based water-and-oil repellent | | | | | | |
| | | (stain resistance) | agent + Resin | | | | | | Acrylic |
| | | | | | | | | | resin |
| | 9 | Drying | 2 min (BL: 130° C. BE: 150° C.) | | | | | | |
| | 10 | First coating | Flame retardant + | | | | | | |
| | | (stain resistance & | Fluorine-based water-and-oil repellent | | | | | | |
| | | flame retardancy) | agent + Acrylic resin | | | | | | |
| | 11 | Drying | 2 min (BL: 130° C. BE: 150° C.) | | | | | | |
| | 12 | Second coating | Flame retardant + | | | | | | |
| | | (flame retardancy) | Acrylic resin | | | | | | |
| | 13 | Drying | 2 min (BL: 130° C. BE: 150° C.) | | | | | | |

| Results | Friction fastness | DRY (Passed at grade 4.0 or higher) | 4.0 | 2.5 | 4.0 | 4.0 | 4.0 | 4.0 |
|---|---|---|---|---|---|---|---|---|
| | | WET (Passed at grade 4.0 or higher) | 4.5 | 2.5 | 4.0 | 4.0 | 4.0 | 4.0 |
| | Flame retardant | Passed at horizontal (mm/min) of | N | 139 | 136 | N | N | 30 |
| | performance | 101 mm/min or less or flame retardancy | | | | | | mm/min |
| | (single fabric) | (N) | | | | | | |
| | Stain resistance | Oil stained or not stained | X | ◯ | ◯ | X | ◯, X | ◯ |
| | test with salad oil | after 83° C. × 24 hrs | | | | | Variation | |
| | | (judged by O, X) | | | | | | |
| | Water repellency | Shower method (points) | | 100 | 100 | 100 | 100 | 100 |
| | | Passed at 95 or higher | | | | | | |
| | Peel strength of | Passed at 1.0 N/cm or higher | | | | | X | ◯ |
| | laminate | | | | | | Vertical: | V: 1.23 |
| | | | | | | | 0.93 | H: 1.45 |
| | | | | | | | Horizontal: | |
| | | | | | | | 0.90 | |
| | Flame retardant | Passed at horizontal (mm/min) of | | | | | N | N |
| | performance | 101 mm/min or less or | | | | | | |
| | (laminated | flame retardancy (N) | | | | | | |
| | composite) | | | | | | | |

| | | | | | | |
|---|---|---|---|---|---|---|
| Overall judgement (⊙, ◯, X) | X | X | X | X | X | ◯ |

| | | | | | |
|---|---|---|---|---|---|
| Processing details | No. 6 | No. 7 | No. 8 | No. 9 | No. 10 |

| | | | | | | | | |
|---|---|---|---|---|---|---|---|---|
| Steps | 1 | Dyeing | Black [BL]/Beige [BE] | BL | BL | BE | BE | BE |
| | | | In-bath flame retardant processing | (+) | (+) | (+) | (+) | (−) |
| | | | Done (+)/Not done (−) | | | | | |
| | 2 | Reduction | Hydrosulfite 1 g/L | | | | | |
| | | cleaning (RC) | Sodium hydroxide 1 g/L | | | | | |
| | | | 80° C. × 30 min | | | | | |
| | 3 | Drying | 2 min (BL: 130° C. BE: 150° C.) | | | | | |
| | 4 | Stain-resistant | Dip-nip | | | | | |
| | | finish | Fluorine-based water and | | | | | |
| | | | oil repellent agent 8.2% | | | | | |
| | | | (150° C. × 2.5 min) | | | | | |
| | 5 | Drying | 2 min (BL: 130° C. BE: 150° C.) | | | | | |
| | 6 | Reduction | Hydrosulfite 1 g/L | | | | | |
| | | cleaning (RC) | Sodium hydroxide 1 g/L | | | | | |
| | | | 80° C. × 15 min | | | | | |
| | 7 | Drying | 2 min (BL: 130° C. BE: 150° C.) | | | | | |
| | 8 | First coating | Fluorine-based water-and-oil repellent | | | | | |
| | | (stain resistance) | agent + Resin | Urethane | Poly- | Urethane | Poly- | |
| | | | | resin | ester | resin | ester | |
| | | | | | resin | | resin | |
| | 9 | Drying | 2 min (BL: 130° C. BE: 150° C.) | | | | | |
| | 10 | First coating | Flame retardant + | | | | | |
| | | (stain resistance & | Fluorine-based water-and-oil repellent | | | | | |
| | | flame retardancy) | agent + Acrylic resin | | | | | |
| | 11 | Drying | 2 min (BL: 130° C. BE: 150° C.) | | | | | |
| | 12 | Second coating | Flame retardant + | | | | | |
| | | (flame retardancy) | Acrylic resin | | | | | |
| | 13 | Drying | 2 min (BL: 130° C. BE: 150° C.) | | | | | |

| Results | Friction fastness | DRY (Passed at grade 4.0 or higher) | 4.0 | 4.0 | 4.0 | 4.0 | 4.0 |
|---|---|---|---|---|---|---|---|
| | | WET (Passed at grade 4.0 or higher) | 4.0 | 4.0 | 4.0 | 4.0 | 4.0 |
| | Flame retardant | Passed at horizontal (mm/min) of | 23 | N | N | N | N |
| | performance | 101 mm/min or less or flame retardancy | mm/min | | | | |
| | (single fabric) | (N) | | | | | |
| | Stain resistance | Oil stained or not stained | ◯ | ◯ | ◯ | ◯ | ◯ |
| | test with salad oil | after 83° C. × 24 hrs | | | | | |
| | | (judged by O, X) | | | | | |
| | Water repellency | Shower method (points) | 100 | 100 | 100 | 100 | 100 |
| | | Passed at 95 or higher | | | | | |
| | Peel strength of | Passed at 1.0 N/cm or higher | ◯ | ◯ | ◯ | ◯ | ◯ |
| | laminate | | V: 1.33 | V: 1.53 | V: 1.43 | V: 1.51 | V: 1.58 |
| | | | H: 1.21 | H: 1.23 | H: 1.25 | H: 1.30 | H: 1.35 |
| | Flame retardant | Passed at horizontal (mm/min) of | N | N | N | N | N |
| | performance | 101 mm/min or less or | | | | | |
| | (laminated | flame retardancy (N) | | | | | |
| | composite) | | | | | | |

| | | | | | |
|---|---|---|---|---|---|
| Overall judgement (⊙, ◯, X) | ◯ | ⊙ | ⊙ | ⊙ | ⊙ |

TABLE 2
Solid contents of chemical agents imparted to the ground fabric by dip-nip or coating (Unit: g/m2)
Ground fabric: Polyester fabric having a basis weight of 360 g/m²

| | | | No. 3 | No. 4 | No. 5 | No. 6 | No. 7 | No. 8 | No. 9 | No. 10 |
|---|---|---|---|---|---|---|---|---|---|---|
| Stain-resistant | Fluorine-based water-and-oil repellent | | 5.27 | 5.27 | 5.27 | 5.27 | 5.27 | 5.27 | 5.27 | 5.27 |
| finish (Step 4) | agent (dip-nip) | | | | | | | | | |
| First Coating | Binder | Acrylic resin | | 29.2 | 63.2 | | | | | 22.2 |
| (Step 8 or 10) | | Polyester resin | | | | | 39.7 | | 36.9 | |
| | | Urethane resin | | | | 30.3 | | 26.9 | | |
| | Thickener (Acrylic resin) | | | | 1.9 | 0.9 | 3.3 | 0.8 | 3.1 | |
| | Organic phosphorus flame retardant | | | 47.0 | | | | | | 35.8 |
| | Fluorine-based water-and-oil repellent agent | | | 2.8 | 1.9 | 0.9 | 2.4 | 0.8 | 2.2 | 3.0 |
| | Total solid contents in first coating (g/m²) | | | 79.0 | 67.0 | 32.1 | 45.4 | 28.5 | 42.2 | 61.0 |
| Second coating | Binder | Acrylic resin | 32.6 | | 21.0 | 29.0 | 29.0 | 30.7 | 30.0 | 14.6 |

| | | | | | | | | |
|---|---|---|---|---|---|---|---|---|
| (Step 12) | Organic phosphorus flame retardant | 52.6 | 34.0 | 46.6 | 46.6 | 49.4 | 48.4 | 23.8 |
| | Total solid contents in second coating (g/m²) | 85.2 | 55.0 | 75.6 | 75.6 | 80.1 | 78.4 | 38.4 |

| | | | | | | | | |
|---|---|---|---|---|---|---|---|---|
| Total solid contents in first and second coating (g/m²) | 85.2 | 79.0 | 122.0 | 107.7 | 121.0 | 108.6 | 120.6 | 99.4 |

As shown in Table 1, the blank fabric (a fabric that had been only subjected to dyeing, in-bath flame retardant treatment, and reduction cleaning) was evaluated to be good in terms of friction fastness and flame retardant performance, but had a poor result in the stain resistance test with salad oil. On the other hand, when the fabric was further subjected to dip-nip processing with a water dispersion containing a fluorine-based water-and-oil repellent agent (fabric No. 1), the stain resistance test with salad oil and water repellency test resulted in good, but the flame retardancy and friction fastness were degraded. On the other hand, when the fabric was subjected to dip-nip treatment and then reduction cleaning (fabric No. 2), the friction fastness was improved to grade 4 in both dry and wet tests, but the flame retardant performance was still insufficient. Further, when a flame-retardant back coat layer was formed on the fabric after the dip-nip treatment (fabric No. 3), the flame retardant performance was resulted in “N”, but occurrence of oil stain was confirmed in the stain resistance test with salad oil. Next, when a flame-retardant stain-resistant back coat layer (one layer only) was formed on the fabric after the dip-nip treatment (fabric No. 4), the flame retardant performance resulted in “N” but in the stain resistance test with salad oil, both spot(s) with oil stain and spot(s) with no stain were observed on the test piece, showing variation in the test results. Further, the peel strength of laminate was insufficient.

On the other hand, when the first coating layer containing a fluorine-based water-and-oil repellent agent was formed on one surface of the fabric and then the second coating layer containing a flame retardant was formed on the first coating layer (fabrics No. 5 to 9), desired characteristics were achieved in all of the peel strength and flame retardancy of the laminated article, in addition to the friction fastness, flame retardancy, stain resistance test with salad oil, and water repellency test of the processed fabric.

Also, when a flame retardant was added to the first coating layer (stain-resistant coating layer) without performing in-bath flame retardant processing during dyeing (fabric No. 10), all of the desired characteristics were achieved. However, due to the addition of the flame retardant to the first coating layer, there appeared a tendency that stain resistance became deteriorated. Therefore, when the flame retardant was added to the first coating layer, it was preferable that the composition of the coating composition and/or the amount of the coating composition applied to the fabric were adjusted so that the fluorine-based water-and-oil repellent agent content of the first coating layer, per unit area of fabric, was 2.5 g/m² or more.

Even though the in-bath flame retardant processing was omitted from the manufacturing steps of fabrics Nos. 5 to 9, the single fabric can achieve “N” in terms of flame retardancy by forming the second coating layer containing the flame retardant. However, there appeared a tendency that the test results of the flame retardancy in the laminated composite showed variation, so that when the fabric laminated to the foam sheet was not subjected to the in-bath flame retardant processing, it was preferable to add a flame retardant to both the first and second coating layers in order to achieve stable flame retardancy.

The total amount of the flame retardant (flame retardants in the first and second coating layers) for fabric No. 10 was larger than the amount of the flame retardant (flame retardant in the second coating layer alone) for fabrics Nos. 5 to 9. As for fabric No. 10, when the total amount of the flame retardant was added only to the second layer without distributing the flame retardant to the first and second layers, the peel strength of the laminate lowered due to the thicker second coating layer. For this reason, instead of improving the flame retardant performance by adding such large amount of flame retardant to only the second layer, it is preferable that the flame retardant is added to the first and second layers separately. At this time, the amount of the flame retardant in the second coating layer is set smaller than that in the first coating layer to thereby make the second coating layer thinner, so that the peel strength of the laminate can be improved. On the other hand, too large amount of the flame retardant in the first coating layer will deteriorate the stain resistance against salad oil. For this reason, these layers are preferably formed so that the amount of the flame retardant in the first coating layer is in the range of 25 g/m² to 45 g/m² and the amount of the flame retardant in the second coating layer is 15 g/m² to 35 g/m².

When the second coating step was not carried out with fabric No. 10, stain resistance and peel strength of laminate became insufficient as seen in fabric No. 4. Therefore, even when the flame retardant was added to the first coating layer, the second coating layer (containing the flame retardant but not containing the water-and-oil repellent agent) was essential.

As for fabrics Nos. 5 to 10, when the order of the first coating layer and the second coating layer was replaced, and the fabric, flame retardant coating layer, and stain resistant coating layer were laminated in this order, oil stain occurred in the stain resistance test, and further, the peel strength of the laminate became insufficient. Therefore, it is essential to laminate the fabric, stain resistant coating layer, and flame retardant coating layer in this order.

From the above experiments, in order to achieve desired flame retardancy, stain resistance, peel strength between the fabric and the foam sheet, and the like, it was found to be effective that the first coating layer containing a fluorine-based water-and-oil repellent agent and the second coating layer containing a flame retardant were provided in the order of the fabric, the first coating layer, and the second coating layer on one surface (in particular the rear surface) of the fabric impregnated with the fluorine-based water-and-oil repellent agent.

### INDUSTRIAL APPLICABILITY

According to the present invention, a polyester fabric can be provided that can prevent contamination due to beverages such as juice and coffee, or water and oils contained in food and that can avoid strike-through of oils even after the fabric is left at a temperature around 80° C. for 24 hours. The fabric of the present invention is suitably used as vehicle interior fabric for automobiles or the like because of its excellent flame retardant performance.

### REFERENCE SIGN LIST IN FIGURES

1: Polyester fabric impregnated with a fluorine-based water-and-oil repellent agent

2: First coating layer

3: Second coating layer

4: Foam sheet

What is claimed is:

1. A fabric comprising:
a first coating layer and a second coating layer on one surface of a polyester fabric impregnated with a fluorine-based water-and-oil repellent agent,
wherein the first coating layer is a layer containing a fluorine-based water-and-oil repellent agent and the second coating layer is a layer containing a flame retardant;
the first coating layer being on the fabric side and the second coating layer being on the side opposite to the fabric of the first coating layer.

2. The fabric according to claim 1, wherein the one surface of the fabric is a rear surface of the fabric.

3. The fabric according to claim 1, wherein a foam sheet is further bonded to the one surface of the fabric.

4. The fabric according to claim 1, wherein the fluorine-based water-and-oil repellent agent content of the first coating layer, per unit area of fabric, is in the range of 0.5 g/m² to 5.0 g/m².

5. The fabric according to claim 1, wherein the first coating layer further comprises a flame retardant.

6. The fabric according to claim 1, wherein the fluorine-based water-and-oil repellent agent content and the flame retardant content of the first coating layer, per unit area of fabric, are in the range of 0.5 g/m² to 3.0 g/m² and 0 g/m², respectively; and
the flame retardant content of the second coating layer, per unit area of fabric, is in the range of 30 g/m² to 60 g/m².

7. The fabric according to claim 1, wherein the fluorine-based water-and-oil repellent agent content and the flame retardant content of the first coating layer, per unit area of fabric, are in the range of 2.5 g/m² to 5.0 g/m² and 25 g/m² to 45 g/m², respectively;
the flame retardant content of the second coating layer, per unit area of fabric, is in the range of 15 g/m² to 35 g/m²; and
the flame retardant content of the first coating layer is larger than the flame retardant content of the second coating layer.

8. The fabric according to claim 1, having flame retardancy and stain resistance.

9. A method for manufacturing a fabric comprising the steps of:
immersing a polyester fabric in a treatment liquid containing a fluorine-based water-and-oil repellent agent to incorporate the treatment liquid into the polyester fabric, followed by drying the fabric;
forming a first coating layer containing a fluorine-based water-and-oil repellent agent on one surface of the fabric; and
forming a second coating layer containing a flame retardant on the first coating layer.
